(19) United States
(12) Patent Application Publication
(10) Pub. No.: US 2016/0088703 A1
(43) Pub. Date: Mar. 24, 2016

(54) CONTROLLER AND CONVERTER INCLUDING FOR THE SAME

(71) Applicant: SAMSUNG ELECTRO-MECHANICS CO., LTD., Suwon-si (KR)

(72) Inventors: Young Jong YOO, Suwon-si (KR); Yun Ki KANG, Seoul (KR); In Hwan CHOI, Suwon-si (KR); Seoung Il KIM, Seongnam-si (KR); Bum Joon KIM, Suwon-si (KR)

(73) Assignee: SAMSUNG ELECTRO-MECHANICS CO., LTD., Suwon-si (KR)

(21) Appl. No.: 14/815,594

(22) Filed: Jul. 31, 2015

(30) Foreign Application Priority Data
Sep. 24, 2014 (KR) 10-2014-0127578

(51) Int. Cl. H05B 33/08; H02M 1/08; H02M 3/158

(52) U.S. Cl. CPC H05B 33/0851; H02M 3/158; H05B 33/0815; H02M 1/08; H02M 2001/0025

(57) ABSTRACT

The object of the present invention is to provide a controller capable of controlling the brightness and preventing an erroneous operation from being generated and a converter including for the same.

The present invention provides a controller including a gate driving unit for outputting a gate signal which is controlled by a feedback signal and a control block for modulating the feedback signal corresponding to a size of a sensing signal, wherein the feedback signal is generated by receiving the sensing signal, and a converter including the same.

### CROSS-REFERENCE TO RELATED APPLICATIONS

Claim and incorporate by reference domestic priority application and foreign priority application as follows:

### Cross Reference to Related Application

This application claims the foreign priority benefit under 35 U.S.C. Section 119 of Korean Patent Application Serial No. 10-2014-0127578, entitled filed Sep. 24, 2014, which is hereby incorporated by reference in its entirety into this application.

### BACKGROUND OF THE INVENTION

1. Field of the Invention

Embodiments of the present invention relates to a controller and converter including for the same.

2. Description of the Related Art

Generally, a converter for LED (Light Emitting Diode) lighting controls the current supplied to an LED module to maintain consistent brightness. The converter for LED lighting uses methods such as PWM (Pulse Width Modulation) or PFM (Pulse Frequency Modulation) to control the current supplied to the LED module. For the LED module, the Vf (LED Forward Voltage) may be determined depending on the number of LEDs connected in series/or parallel and the power consumption of each LED. Also, the converter for LED lighting has a range for the output voltage, and if the Vf of the LED module is between the range of the output voltage, the converter for LED lighting controls the current supplied to the LED module to eradiate consistent brightness. However, if the Vf of the LED module is outside the range of the output voltage, consistent lighting is impossible since the converter for LED lighting cannot control the current.

Also, the converter for LED lighting is controlled by the feedback of the size of the current supplied to the LED module, however, it will cause malfunction if the size of the current supplied to the LED module is too small. Especially, when the dimming control is performed to control the brightness of the LED module, the current flowing through the LED module may be very small causing the converter for LED lighting to easily malfunction.

### SUMMARY OF THE INVENTION

The object of the present invention is to provide a controller and a converter including form the same that controls the brightness and prevents malfunction.

In accordance with a primary aspect of the present invention to achieve the object, there is provided a controller including a gate driving unit for outputting a gate signal which is controlled by a feedback signal and a control block for modulating the feedback signal corresponding to a size of a sensing signal, wherein the feedback signal is generated by receiving the sensing signal.

In accordance with a secondary aspect of the present invention to achieve the object, there is provided a converter including a sensing unit for sensing a size of current flowing through an LED module for outputting a sensing signal, a converting unit for supplying the current to the LED module and a controller for controlling the converting unit, wherein the controller includes a gate driving unit for outputting a gate signal which is controlled by a feedback signal and a control block for modulating the feedback signal corresponding to a size of the sensing signal, wherein the feedback signal is generated by receiving the sensing signal.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a structural drawing of a converter in accordance with an embodiment of the present invention;

FIG. 2 is a circuit diagram of a converter connected with an LED module including one LED row;

FIG. 3 is a circuit diagram of the converter connected with the LED module including a plurality of LED rows;

FIG. 4 is a circuit diagram of a control block employed on a converter according to a primary embodiment of the present invention;

FIG. 5 is a circuit diagram of a control block employed on a converter according to a secondary embodiment of the present invention; and

FIG. 6 is a structural drawing of an embodiment of a feedback controller shown in FIG. 4.

### DESCRIPTION OF EMBODIMENTS

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

The objects, specific advantages, and novel features of the present invention will become more apparent from the following detailed description and preferable embodiments when taken in conjunction with the accompanying drawings. In the specification, in adding reference numerals to elements of each drawing, it is to be noted that like reference numerals like elements even through elements are shown in different drawings. Further, in describing the present invention, a detailed description of related well-know techniques will be omitted so as not to obscure the subject of the present invention. In the specification, the terms “first”, “second”, and so on are used to distinguish between similar elements and do not limit the elements.

Hereinafter, configurations and operational effects of the present invention will be described in detail with reference to the accompanying drawings.

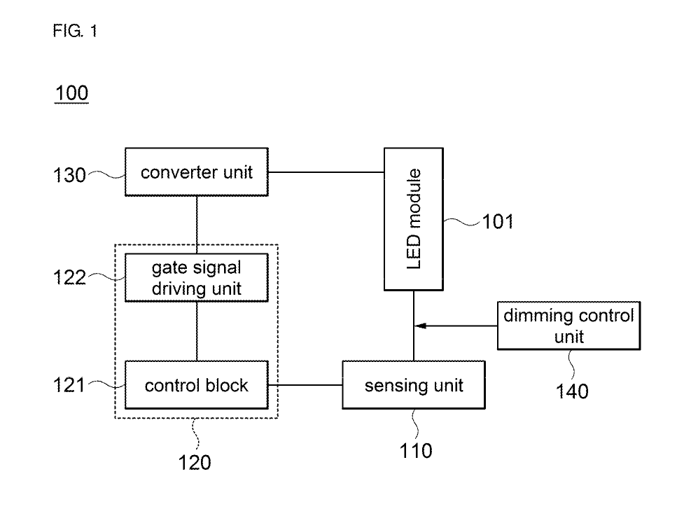

FIG. 1 is a structural drawing of a converter in accordance with an embodiment of the present invention.

Referring to FIG. 1, a converter 100 may include a sensing unit 110 to detect current flowing through a LED module 101, a converting unit 130 that supplies the current to the LED module 101, and a controller 120 which controls the converting unit 130, wherein the controller 120 is controlled by a feedback signal and may include a gate driving unit 122 that outputs a gate signal which controls the converting unit 130, and a control block 121 that receives a sensing signal and generates the feedback signal, wherein the feedback signal is modulated corresponding to the intensity of the sensing signal. Also, the converter 100 may further include a dimming controller 140 that controls the current flowing through the LED module to adjust the brightness of the LED module 101. The LED module 101 may include a channel 1011a that equips a plurality of LEDs. Also, the LED module 101 may include a row of LEDs or a plurality of LED rows.

The converter 100 consisted as above enables the current to flow from the converting unit 130 to the LED module 101, the sensing unit 110 detects the current flowing through the LED module 101 and generates the sensing signal corresponding to the current. The sensing signal may be used to output the gate signal to control the converting unit 130. The sensing signal may be used as the feedback signal. Also, the gate signal may be generated corresponding to the feedback signal. Here, if the current flowing through the LED module 101 is very small, the output of the gate signal may not be strong enough to control the operation of the converting unit 130, thus the brightness of the LED module 101 may not be even. Especially, if the converter 100 includes the dimming controller 140 which controls the brightness of the LED module, the current flowing through the LED module 101 may be very due to a dimming control signal generated from the dimming controller 120. If the current flowing through the LED module 101 is very small, the sensing signal may be very weak resulting in a weak gate signal and exact control of the operation of the converting unit 130 may not possible.

To solve the problem described above, the converter 100 may equip the control block 121 to modulate the feedback signal corresponding to the intensity of the sensing signal. That is, if the current flowing through the LED module is very weak, the output of the gate signal can be extended by modulating the feedback signal corresponding to the sensing signal in the control block 121. The gate signal may be modulated by increasing the voltage or the duration of an on-time of the gate signal. However, it is not limited thereto.

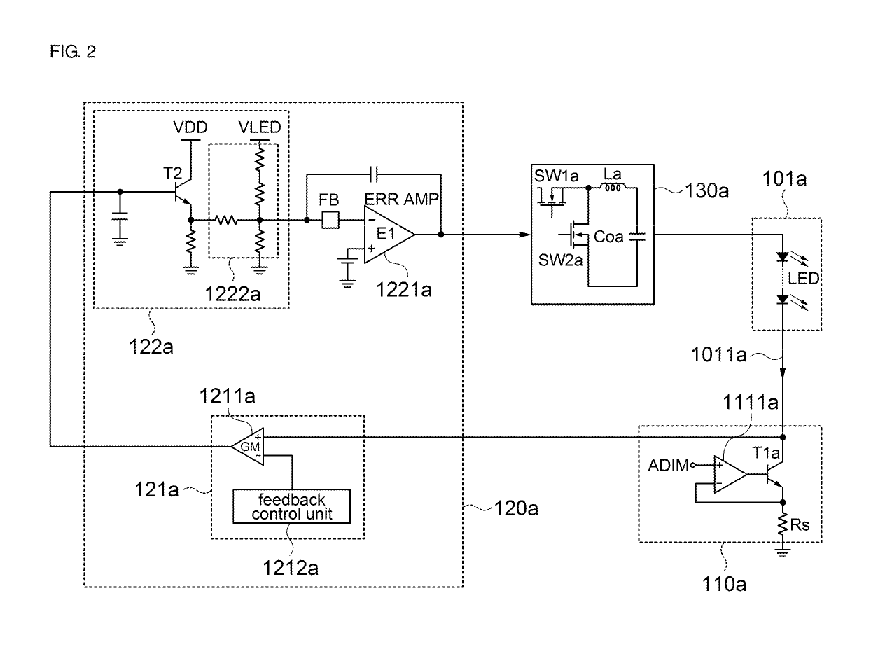

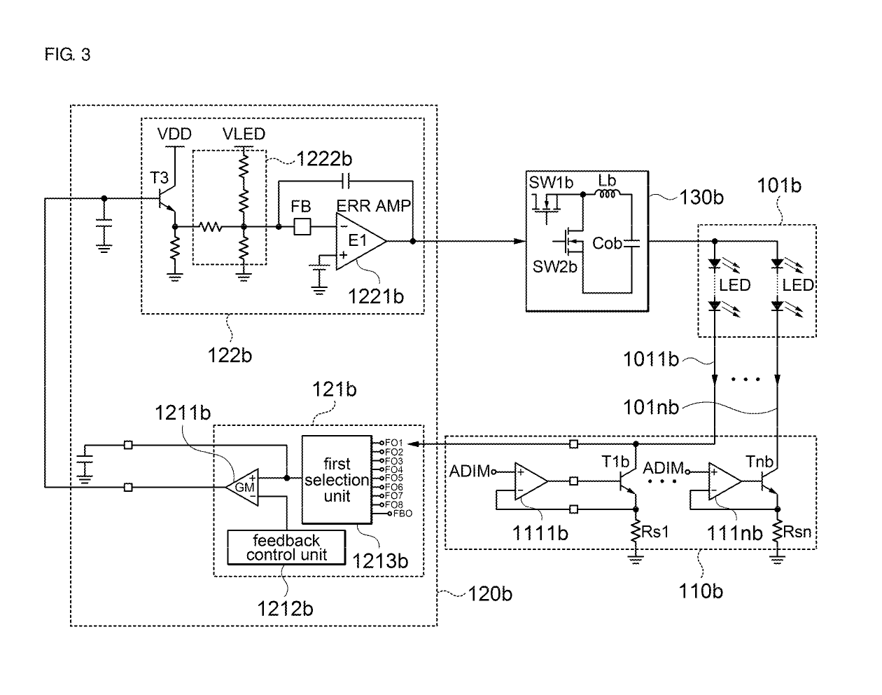

FIG. 2 is a circuit diagram of a converter connected with an LED module including one LED row and FIG. 3 is a circuit diagram of the converter connected with the LED module including a plurality of LED rows.

Referring to FIG. 2 and FIG. 3, the converter 100 may include converting units 130a and 130b which provides current to the LED modules 101a and 101b, sensing units 110a and 110b which detect the current flowing through the LED modules 101a and 101 b and generates a sensing signal, control blocks 121a and 121b which generate a feedback signal corresponding to the sensing signal, and gate driving units 122a and 122b which receive the feedback signal and output a gate signal.

The LED modules 101a and 101b may include a channel 1011a, as shown in FIG. 2, or a plurality of channels 1011b through 101nb as shown in FIG. 3. Each channel 1011a through 101nb may have an LED bar containing a plurality of LEDs. Also, when the LED module 101a includes only one channel 1011a, as shown in FIG. 2, one sensing unit 110a may detect the current flowing through one channel 1011a and when the LED module 101b includes the plurality of channels 1011b through 101nb, as shown in FIG. 3, a plurality of sensing units 110b may be used to connect each channel 1011b through 101nb to each sensing unit 110b.

The converting unit 130a and 130b may include inductors La and Lb, first switch SW and SW1b, and second switches SW2a and SW2b. The first switches SW and SW and the second switches SW2a and SW2b may switch the current flowing through the inductors La and Lb turned on or turned off by the gate signal. Here, the converting units 130a and 130b may be a buck converter, however, this is an example and it is not limited thereto.

The sensing units 110a and 110b may include a transistor T1a, a sensing resistor Rs, and a comparator 1111a to detect the current flowing through the LED modules 101a and 101 b. Also, a first terminal of the transistors T1a and T1b may be connected to the LED modules 101a and 101b and a second terminal may be connected to the sensing resistor Rs, and a gate terminal may be connected to an output terminal of the comparator 1111a. The transistor T1a may be a BJT (Bipolar junction transistor), MOS (Metal oxide Semiconductor) transistor, or FET (Field effect transistor) etc. Additionally, a terminal of the sensing resistor Rs may be connected to the second terminal of the transistor T1a, another terminal is connected to the ground. Also, for the comparators 1111a and 1111b, an ADIM (Analog dimming) is connected to a positive (+) input terminal of the comparators 1111a and 1111b and a terminal of the sensing resistor Rs may be connected to a negative (−) input terminal. The comparator 1111a can set the amplitude size of the current by the size of the fixed voltage incoming through the positive (+) terminal. By controlling the amount of current flowing through the channel by the amplitude size of the current, dimming control of the brightness may be done. In the sensing units 110a and 110b, the turn-on/turn-off state of the transistors T1a and T1b may be determined by the signal generated from the comparators 1111a and 1111b, and the voltage applied to the sensing resistor by the flow of current may by delivering to the control blocks 121a and 121b. The voltage applied to the sensing resistor Rs can be the sensing signal. If there is one sensing unit 110a, the sensing signal can be a voltage signal, and if there are pluralities of sensing units 110b, the sensing signal can be a plurality of voltage signals in parallel delivered from each sensing unit 110b.

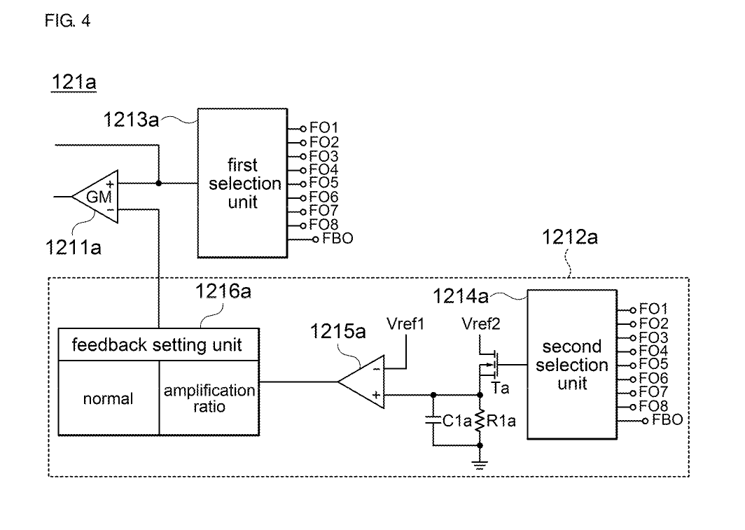

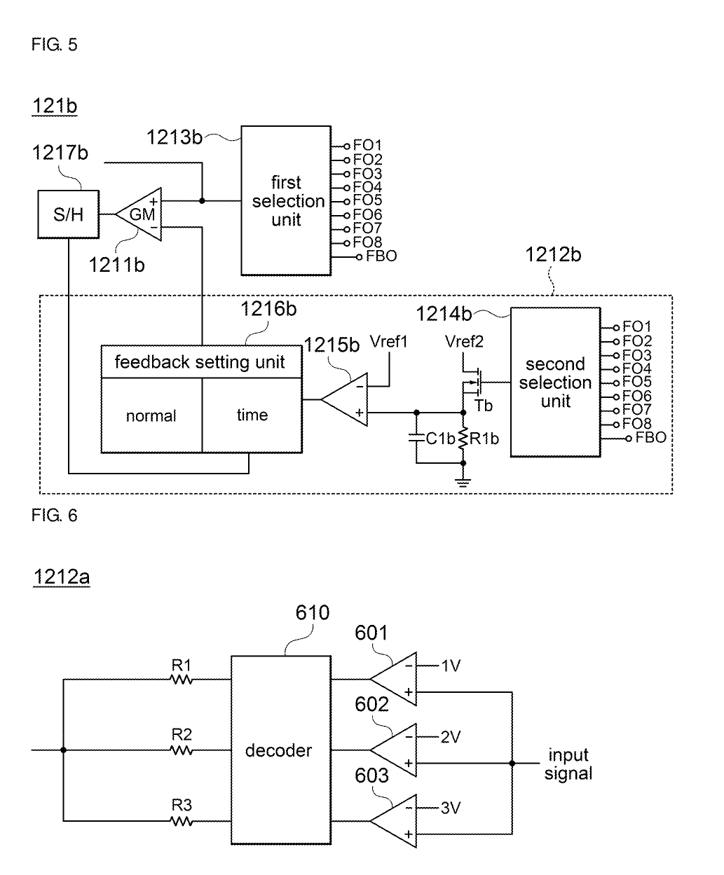

The control block 121 may include amplifiers 1211a and 1211b and feedback controllers 1212a and 1212b. The amplifiers 1211a and 1211b may receive the sensing signal from a positive (+) input terminal and a signal delivered from the feedback controllers 1212a and 1212b from a negative (−) input terminal. Additionally, the amplifiers 1211a and 1211b may amplify the sensing signal to output the feedback signal. Here, if the sensing signal is very small, the outputted feedback signal may not be large enough even if the sensing signal is amplified by the amplifiers 1211a and 1211b at a constant ratio. To solve the problem, the feedback controllers 1212a and 1212b may increase the amplitude ratio and the on-time of the feedback signal. Also, at the feedback controllers 1212a and 1212b, when there is one voltage signal for the sensing signal, the delivered sensing signal may be used for outputting the feedback signal and when there are pluralities of voltage signals in parallel delivered of sensing signals, one voltage signal may be selected from the plurality of voltage and used to output the feedback signal. The structures of the feedback controllers 1212a and 1212b are described using FIG. 4 and FIG. 5 shown below. Also, the amplifiers 1211a and 1211b may be a transconductance amplifier, but it is not limited thereto.

The gate driving unit 122 may receive the feedback signal and generate the gate signal. By the gate signal, the first switches SW1a and SW1b and the second switches SW2a and SW2b of the converting units 130a and 130b may repeat the turn-on/turn-off operation to generate an output voltage (VLED). The gate driving units 122a and 122b may include a transistors T2 and T3 which the feedback signal sent out from the control block is received in the gate terminal, a pair of resistor rows 1222a and 1222b which divide the output voltage depending on the resistor ratio, and error amplifiers 1221a and 1221b which amplify the divided voltage. Furthermore, an output signal of the error amplifiers 1221a and 1221b can be a gate signal.

FIG. 4 is a circuit diagram of a control block employed on a converter according to a primary embodiment of the present invention.

Referring to FIG. 4, the control block 121a may include an amplifier 1211a which outputs a feedback signal by amplifying an input signal corresponding to a sensing signal and a feedback controller 1216a which controls the amplification ratio of the amplifier 1211a corresponding to the size of the sensing signal. In the amplifier 1211a, the amplification ratio may be controlled by adjusting the impedance value of a negative (−) input terminal, but it is not limited thereto. If the sensing signal generated from the sensing unit 110a is a single voltage signal, the input signal incoming through the amplifier 1211a can be the sensing signal, or if the sensing signal generated from the sensing unit 110a are a plurality of voltage signals, the input signal incoming through the amplifier can be one signal selected from the plurality of sensing signals. To select a signal from the plurality of sensing signals, the control block may further include a first signal selector 1213a, which receives the sensing signal and selects one sensing signal then sends out the input signal. The input signal corresponding to the sensing signal selected from the first signal selector 1213a can be sent to the amplifier 1211a. Also, the first signal selector 1213a can select the lowest-voltage sensing signal out of the plurality of sensing signals. Having the lowest voltage in a sensing signal can be meant that the voltage applied at a channel connected to the sensing unit 110b that sent out the sensing signal is the highest of them all. If the voltage applied to the channel is high, then that can be judged as a brightest channel 1011b. By using the brightest channel 1011b to control the flow of current may be more convenient in controlling the whole brightness of a LED module.

Also, to select a signal from the plurality of sensing signals, the control block 121a may further include a second signal selector 1214a which sends out the input signal corresponding to a selected signal selected one out of the plurality of sensing signals and a comparator 1215a which compares the voltage corresponding to the input signal selected from the second signal selector with a first reference voltage Vref1. The signal that the second signal selector 1214 receives may be the same signal, which the first signal selector 1213a receives. Also, the control block 121a may include a transistor Ta to receive an output signal of the second signal selector 1214a at a gate terminal, a first terminal of the transistor Ta may be connected to a second reference voltage Vref2 and a second terminal of the transistor Ta may be connected each to a capacitor C1a and a resistor R1a in parallel. Additionally, the transistor Ta is turned on corresponding to the output signal of the second signal selector 1214a, the level of voltage saved at the capacitor C1a corresponding to the output signal of the second signal selector 1214a may be differentiated. Also, the capacitor C1a and the resistor connected in parallel with the capacitor C1a acts as a low-pass filter to smooth the voltage saved at the capacitor C1a. Furthermore, the comparator 1215 can compare the first reference voltage Vref1 to the voltage saved at the capacitor C1a to judge if the selected input signal is higher than a predetermined fixed value. That is, if the input signal is higher than the first reference voltage Vref1, it can be judged that the input signal is higher than the fixed value and if the input signal is lower than the first reference value Vref1, then it can be judge that the input signal is lower than the fixed value.

The control block 121a may further include a feedback setting unit 1216a which judges whether to change the amplification ratio corresponding to the output signal of the comparator 1215a. If the sensing signal is judged higher than the fixed value, the feedback setting unit 1216a judges as a normal operation and sends out the feedback signal by amplifying the input signal without changing the amplification ratio, and if the sensing signal is judged lower than the fixed value, the feedback setting unit 1216a changes the amplification ratio of the amplifier 1211a to send out the feedback signal by amplifying the selected input signal corresponding to the changed amplification ratio. The feedback setting unit 1216a may change the amplification ratio by adjusting the impedance value of the negative (−) input terminal in the amplifier 1211a. The changed amplification ratio may have a higher value than the predetermined amplification ratio.

Here, it is described that the control block 121a includes the first signal selector 1213a and the second signal selector 1214a. If else, the control block 121a sends the output of the first signal selector 1213a to the amplifier 1211a and the transistor Ta, respectively to enable the operation of the control block 121a so as for the control block 121a to only include the first signal selector 1213a.

FIG. 5 is a circuit diagram of a control block employed on a converter according to a secondary embodiment of the present invention.

Referring to FIG. 5, a control block 121b may include a amplifier 1211b which outputs a feedback signal by amplifying an input signal corresponding to a sensing signal and a feedback controller which controls the on-time of the feedback signal sent out from the amplifier 1211b corresponding to the size of the sensing signal. An impedance value connected to a negative (−) input terminal of the amplifier 1211b may be fixed, thus the amplification ratio of the amplifier 1211b may be fixed, but it is not limited thereto. A feedback setting unit 1216b may control the amplification ratio of the amplifier 1211b and the on-time of the feedback signal. In addition, if the sensing signal generated from a sensing unit 110a is a single voltage signal, the input signal incoming through the amplifier 1211b can be the sensing signal, or if the sensing signal generated from the sensing unit 110a are a plurality of voltage signals, the input signal incoming through the amplifier can be one signal selected from the plurality of sensing signals. To select a signal from the plurality of sensing signals, the control block may further include a first signal selector 1213b, which receives the sensing signal and selects one sensing signal then sends out the input signal. The input signal selected from the first signal selector 1213b can be sent to the amplifier 1211b. Also, the first signal selector 1213b can select the lowest-voltage sensing signal out of the plurality of sensing signals. Having the lowest voltage in a sensing signal can be meant that the voltage applied at a channel 1011b connected to the sensing unit that sent out the sensing signal is the highest of them all. If the voltage applied to the channel is high, then that can be judged as a brightest channel 1011b. By using the brightest channel 1011b to control the flow of current may be more convenient in controlling the whole brightness of a LED module 101.

Also, to select a signal from the plurality of sensing signals, the control block 121b may further include a second signal selector 1214b which sends out the input signal corresponding to a selected signal selected one out of the plurality of sensing signals and a comparator 1215b which compares the voltage corresponding to the input signal selected from the second signal selector with a first reference voltage Vref1. The signal that the second signal selector 1214b receives may be the same signal, which the first signal selector 1213b receives. Also, the control block 121 may include a transistor Tb to receive an output signal of the second signal selector 1214b at a gate terminal, a first terminal of the transistor Tb may be connected to a second reference voltage Vref2 and a second terminal of the transistor Tb may be connected each to a capacitor C1a and a resistor R1a in parallel. Additionally, the transistor Tb is turned on corresponding to the output signal of the second signal selector 1214b, the level of voltage saved at the capacitor C1b corresponding to the output signal of the second signal selector 1214b may be differentiated. Also, the capacitor C1b and the resistor connected in parallel with the capacitor C1b acts as a low-pass filter to smooth the voltage saved at the capacitor C1b.

In addition, the comparator 1215b can compare the first reference voltage Vref1 to the voltage saved at the capacitor C1b to judge if the selected input signal is higher than a predetermined fixed value. That is, if the input signal is higher than the first reference voltage Vref1, it can be judged that the input signal is higher than the fixed value and if the input signal is lower than the first reference value Vref1, then it can be judge that the input signal is lower than the fixed value.

The control block 121a may further include a feedback setting unit 1216b which judges whether to change the amplification ratio corresponding to the output signal of the comparator 1215b. If the sensing signal is judged higher than the fixed value, the feedback setting unit 1216b judges as a normal operation and lets the on-time of the feedback signal be a predetermined value. In addition, if the sensing signal is judged lower than the fixed value, the feedback setting unit 1216b may change the on-time of the feedback signal to a higher value than the fixed value. The feedback setting unit 1216b may control the length of the output signal longer by controlling a sample/hold circuit 1217b connected to the output terminal of the amplifier 1215b. Thus, the on-time of the feedback signal may be longer than the predetermined value.

Here, it is described that the control block 121b includes the first signal selector 1213b and the second signal selector 1214b. If else, the control block 121a sends the output of the first signal selector 1213b to the amplifier 1211b and the transistor Tb, respectively, to enable the operation of the control block 121b so as for the control block 121b to only include the first signal selector 1213b.

FIG. 6 is a structural drawing of an embodiment of a feedback controller shown in FIG. 4.

Referring to FIG. 6, a feedback controller 1212a may include a first comparator 601 to a third comparator 603 to compare a first voltage corresponding to an input signal to a first reference voltage with a different value and a feedback setting unit 1216a to select the on-time corresponding to outputs of each comparator. Each of the first comparator 601 to the third comparator 603 receives voltage (voltage saved in capacitor C1a in FIG. 4) corresponding to the input signal through a positive (+) input terminal and the first reference voltage with a different value through a negative (−) input terminal. Also, the feedback setting unit 1216a may further include a decoder 610, which selects an impedance value corresponding to the outputs of each comparator 601, 602 and 603. Here, it is described that the first comparator 601 receives 1V of the first reference voltage, the second comparator 602 receives 2V of the first reference voltage, and the third comparator receives 3V of the first reference comparator, however, 1V, 2V, 3V are an example and it is not limited thereto. Also, the first comparator 601, the second comparator 602, and the third comparator 603 may each send out signals depending on the voltage corresponding to each input signals. If the voltage referring to the input signal of the decoder 610 is higher than 3V, the first comparator 601, the second comparator 602, and the third comparator 603 may each send out a 1 signal. In addition, if the voltage corresponding to the input signal is between 2V and 3V, the first comparator 601 and the second comparator 602 may send out the 1 signal and the third comparator may send out a 0 signal. In addition, of the voltage corresponding to the input signal is between 1V and 2V, the first comparator 601 may send out the 1 signal, the second comparator and third comparator 603 may send out the 0 signal. Also, if the voltage corresponding to the input signal is less than 1V, the first comparator 601, the second comparator 602, and the third comparator 603 may send out the 0 signal. In addition, the decoder may select a resistance of four different impedance values depending on the output and change the amplification ratio of an amplifier 1211a by connecting the resistance to a negative (−) input terminal of the amplifier 1211a. Here, it is only described only by selecting a row of resistors R1, R2, and R3 to change the amplification ratio of the amplifier. However, it is not limited thereto; changing the on-time of the feedback signal according to the output signal of the first comparator 601 to the third comparator 603 in the decoder 610 is possible.

According to the converter and controller including the same, if the detected sensing current is small, this prevents the degradation of signal quality to prevent malfunction. Also, the converter may widen the range of the driving voltage to widen the range of intensity modulation.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A controller comprising:
a gate driving unit for outputting a gate signal which is controlled by a feedback signal; and
a control block for modulating the feedback signal corresponding to a size of a sensing signal,
wherein the feedback signal is generated by receiving the sensing signal.

2. The controller according to claim 1, wherein the control block includes an amplifier for outputting the feedback signal by receiving an input signal corresponding to the sensing signal and a reference voltage and a feedback controller for controlling an amplification ratio of the amplifier corresponding to a size of the input signal.

3. The controller according to claim 2, wherein the feedback controller includes a comparator for comparing a first voltage corresponding to the input signal to a first reference voltage and a feedback setting unit for selecting the amplification ratio in response to an output of the comparator.

4. The controller according to claim 2, wherein the feedback controller includes a first comparator to a third comparator for comparing a first voltage corresponding to the input signal to a first reference voltage having a different size and a feedback setting unit for selecting the amplification ratio corresponding to outputs of each comparator, wherein the feedback setting unit includes a decoder for selecting an impedance value of the amplifier corresponding to outputs of each comparator.

5. The controller according to claim 3, wherein the control block further includes a signal selector for selecting one sensing signal by receiving a plurality of sensing signals and for outputting the input signal corresponding to the selected sensing signal; and, the input signal outputted from the signal selector is transmitted to the amplifier.

6. The controller according to claim 3, wherein the control block generates the first voltage corresponding to the input signal and a second reference voltage.

7. The controller according to claim 1, wherein the control block includes an amplifier for outputting the feedback signal by receiving an input signal corresponding to the sensing signal and a reference voltage and a feedback controller for controlling an on-time of an outputting signal of the amplifier corresponding to a size of the input signal.

8. The controller according to claim 7, wherein the feedback controller includes a comparator for comparing a first voltage corresponding to the input signal to a first reference voltage and a feedback setting unit for selecting an amplification ratio of the amplifier in response to an output of the comparator.

9. The controller according to claim 8, wherein a sample/hold circuit is additionally connected to an output terminal of the amplifier and the on-time is maintained in the sample/hold circuit by the on-time selected by the feedback setting unit.

10. The controller according to claim 9, wherein the feedback controller includes a first comparator to a third comparator for comparing the first voltage corresponding to the input signal to the first reference voltage having a different size and a feedback setting unit for selecting the on-time corresponding to outputs of each comparator, wherein the feedback setting unit includes a decoder for selecting the on-time in the sample/hold circuit corresponding to outputs of each comparator.

11. The controller according to claim 9, wherein the control block further includes a signal selector for selecting one sensing signal by receiving a plurality of sensing signals and for outputting the input signal corresponding to the selected sensing signal; and, the input signal outputted from the signal selector is transmitted to the amplifier.

12. The controller according to claim 8, wherein the control block generates the first voltage corresponding to the input signal and a second reference voltage.

13. A converter comprising:
a sensing unit for sensing a size of current flowing through an LED module for outputting a sensing signal;
a converting unit for supplying the current to the LED module; and
a controller for controlling the converting unit,
wherein the controller includes:
a gate driving unit for outputting a gate signal which is controlled by a feedback signal; and
a control block for modulating the feedback signal corresponding to a size of the sensing signal,
wherein the feedback signal is generated by receiving the sensing signal.

14. The converter according to claim 13, wherein the control block includes an amplifier for outputting the feedback signal by receiving an input signal corresponding to the sensing signal and a reference voltage and a feedback controller for controlling an amplification ratio of the amplifier corresponding to a size of the input signal.

15. The converter according to claim 14, wherein the feedback controller includes a comparator for comparing a first voltage corresponding to the input signal to a first reference voltage and a feedback setting unit for selecting the amplification ratio in response to an output of the comparator.

16. The converter according to claim 14, wherein the feedback controller includes a first comparator to a third comparator for comparing a first voltage corresponding to the input signal to a first reference voltage having a different size and a feedback setting unit for selecting the amplification ratio corresponding to outputs of each comparator, wherein the feedback setting unit includes a decoder for selecting an impedance value of the amplifier corresponding to outputs of each comparator.

17. The converter according to claim 15, wherein the control block further includes a signal selector for selecting one sensing signal by receiving a plurality of sensing signals and for outputting the input signal corresponding to the selected sensing signal; and, the input signal outputted from the signal selector is transmitted to the amplifier.

18. The converter according to claim 15, wherein the control block generates the first voltage corresponding to the input signal and a second reference voltage.

19. The converter according to claim 13, wherein the control block includes an amplifier for outputting the feedback signal by receiving an input signal corresponding to the sensing signal and a reference voltage and a feedback controller for controlling an on-time of an outputting signal of the amplifier corresponding to a size of the input signal.

20. The converter according to claim 19, wherein the feedback controller includes a comparator for comparing a first voltage corresponding to the input signal to a first reference voltage and a feedback setting unit for selecting an amplification ratio of the amplifier in response to an output of the comparator.

21. The converter according to claim 20, wherein a sample/hold circuit is additionally connected to an output terminal of the amplifier and the on-time is maintained in the sample/hold circuit by the on-time selected by the feedback setting unit.

22. The converter according to claim 21, wherein the feedback controller includes a first comparator to a third comparator for comparing the first voltage corresponding to the input signal to the first reference voltage having a different size and a feedback setting unit for selecting the on-time corresponding to outputs of each comparator, wherein the feedback setting unit includes a decoder for selecting the on-time in the sample/hold circuit corresponding to outputs of each comparator.

23. The converter according to claim 21, wherein the control block further includes a signal selector for selecting one sensing signal by receiving a plurality of sensing signals and for outputting the input signal corresponding to the selected sensing signal; and, the input signal outputted from the signal selector is transmitted to the amplifier.

24. The converter according to claim 23, wherein the control block generates the first voltage corresponding to the input signal and a second reference voltage.

25. The converter according to claim 17, wherein the LED module includes a plurality of LED rows and the sensing unit is connected to the plurality of LED rows and generates the plurality of sensing signals.

26. The converter according to claim 13, further comprises:
a dimming controller for adjusting brightness of the LED module by controlling current flowing through the LED module.
